(19) United States
(12) Patent Application Publication
(10) Pub. No.: US 2013/0149531 A1
(43) Pub. Date: Jun. 13, 2013

(54) ADHESIVE MATERIAL

(71) Applicant: Zephyros, Inc., Romeo, MI (US)

(72) Inventors: David J. Kosal, Columbus, MI (US); Abraham Kassa, Shelby Township, MI (US); Kevin Hicks, Harrison Township, MI (US)

(73) Assignee: ZEPHYROS, INC., Romeo, MI (US)

(21) Appl. No.: 13/708,295

(22) Filed: Dec. 7, 2012

Related U.S. Application Data
(60) Provisional application No. 61/568,260, filed on Dec. 8, 2011.

(51) Int. Cl. C09J 163/00; B32B 7/12

(52) U.S. Cl. CPC C09J 163/00; B32B 7/12
USPC 428/354; 523/438

(57) ABSTRACT

An adhesive material and articles incorporating the same is disclosed. The adhesive material includes a liquid epoxy resin and rubber, a solid epoxy resin and rubber, one or more curing agents, and a filler.

### FIELD

The present teachings relate generally to an adhesive material, formation of the adhesive material, and application of the material to components of articles of manufacture such as automotive vehicles.

### BACKGROUND

The present teachings relate to a polymeric adhesive. The adhesive is especially useful in bonding a glass surface to a metal surface, for example, interior automotive components such as rear view mirrors and sensor brackets to windshields.

While there are known adhesives for glass to metal bonding, the transportation industry continues to seek adhesive compositions that are able to withstand a wide range of environmental conditions including extreme temperatures and humidity levels. Often, materials that may withstand such extremes are unsuitable for adhering to specific materials. More specifically, many of these adhesives fail to perform effectively when required to adhere to multiple types of materials that may expand and contract at different rates and amounts due to the changes in temperatures and/or humidity levels. Further, these compounds may not adhere to multiple types of materials in the green state and thus one or more of the materials and/or adhesives may become disconnected before and/or during the curing process. Some adhesives may use compounds that are detrimental to the environment such as volatile organic compounds in order to obtain a uniform thin film on one or both of the surfaces. Examples of some adhesives are disclosed in U.S. Pat. Nos. 5,587,236; 5,883.193; 6,111,015; 6,348,118; 6,530,791; 6,573,309; 6,803,111; and 7,473,715; U.S. Patent Application Publication Nos. 2004/0204551; 2007/0088138; 2008/0188609; 2008/0254214; 200910004423; and International Patent Application No. WO2009/124709. Thus, there is a need for an improved adhesive material that exhibits durability in response to environmental extremes while also effectively adhering to a multitude of varying substrates. There is also a need for adhesives that are environmentally friendly and can be made into a film having uniform thickness without the use of volatile organic compounds such as solvents. There is a further need for an adhesive that can accommodate the different rates of thermal expansion of different materials connected by the adhesive. What is further needed is an adhesive that attaches to multiple types of material so that the multiple types of materials are held together before curing and the adhesive continues to hold the materials together as the curing process begins and after cure has taken place.

### SUMMARY

The present teachings contemplate a heat activated polymeric adhesive composition comprising at least one liquid epoxy including a rubber, at least one solid epoxy including a rubber, and an epoxy cure activator that activates curing at a temperature as low as about 120° C. The at least one liquid epoxy including a rubber may be present in an amount of at least about 10% by weight to about 40% by weight of the total adhesive composition. The at least one solid epoxy including a rubber may be present in an amount of at least about 30% by weight to about 60% by weight of the total adhesive composition. More particularly, the rubber component may be provided as part of both a liquid epoxy/rubber composition and a solid epoxy/rubber composition.

The present teachings further contemplate a process for bonding two dissimilar surfaces together comprising contacting the two surfaces together with the adhesive composition of the teachings disposed between the two surfaces and allowing the adhesive to cure and bond the surfaces together.

The adhesive of these teachings is capable of bonding a metal surface such as rear view mirror mount to a glass surface such as a windshield so that the mirror mount and glass will remain in contact with the adhesive at temperatures above −30° C. and below 90° C. and humidity levels above 80 percent.

### DESCRIPTION OF THE DRAWINGS

FIG. 1 is an illustrative example of an adhesive in accordance with the present teachings shown with two surfaces.

FIG. 2 shows the adhesive of FIG. 1 located onto a surface.

FIG. 3 shows the adhesive of FIG. 1 located between two surfaces.

FIG. 4 shows the adhesive of FIG. 1 in use with a mirror device.

FIG. 5 is an illustrative processing system in accordance with the present teachings.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application is related to and claims the benefit of the priority date of U.S. Provisional Application Ser. No, 61/568,260, filed on Dec. 8, 2011. The entirety of that application is hereby incorporated by reference for all purposes.

The present teachings are predicated upon provision of an improved adhesive material, the method of making the improved adhesive material, and use of the improved adhesive material. The adhesive material is typically employed for providing structural adhesion to a first surface and a second surface, wherein the first and second surfaces may consist of dissimilar materials. The first and second surfaces may also be formed of the same material. The first and second surfaces may be components of an article of manufacture such as an automotive vehicle. Preferably, the first surface is automotive glass and the second surface is a holder that is adhered to the automotive glass in order to support an automotive component.

The first surface may be any automotive surface. Preferably, the first surface may be glass, Plexiglas, safety glass, or a combination thereof. More preferably, the first surface may be a windshield of a vehicle. The second surface may be any surface that may be connected to the first surface. Preferably, the second surface may be any surface that may support an automotive component. More preferably, the second surface may be any surface that may secure sensor brackets to a windshield. Even more preferably, the second surface may be any surface that may secure a rear view mirror to a windshield. The second surface may be made of any material. The second surface may be made of metal, plastic, glass, a polymer, or a combination thereof. Preferably, the second surface is made of stainless steel.

The adhesive may be any adhesive of the teachings herein. Preferably, the adhesive may adhere the first surface and the second surface and remain adhered when a vehicle component is further attached to the second surface. More preferably, the adhesive may adhere a stainless steel second surface to a glass windshield first surface so that a rear view mirror may be held in place. The adhesive material may be an activatable material. As used herein, the phrase activatable material includes any material that may be activated to met, flow, cure (e.g., thermoset), expand, foam or a combination thereof by an ambient condition or another condition. For example, the material may expand, foam, flow, melt, cure, a combination thereof, or the like upon exposure to a condition such as heat, pressure, chemical exposure, moisture, combinations thereof, or the like. The adhesive material may be a latent cure material.

The adhesive material typically includes a polymeric material (e.g., epoxy resin) and one or a combination of a thermoplastic, impact modifier, rheology modifier, crosslinking agent/curing agent, tackifier, and filler. The activatable material preferably includes at least three, four, or more of the following:
(a) about 2 to about 60 percent by weight solid epoxy resin, which may include a rubber;
(b) about 2 to about 60 percent by weight liquid epoxy resin, which may include a rubber;
(c) one or more additional polymers and/or copolymers;
(d) about 0.2 to about 10 percent by weight curing agent; and
(e) filler.

The activatable material more preferably may include at least three, four, or more of the following:
(a) about 15 to about 60 percent by weight solid epoxy resin, which may include a rubber;
(b) about 10 to about 40 percent by weight liquid epoxy resin which may include a rubber:
(c) about 5 to bout 20 percent by weight ethylene terpolymer;
(d) about 2 to about 20 percent by weight filler;
(e) about 0.5 to about 15 percent by weight primary curing agent;
(f) about 0.1 to about 5 percent by weight a secondary curing agent;
(g) about 0.1 to about 3 percent by weight accelerator; and
(h) about 0.5 to about 3 percent pigment.

The concentrations may be higher or lower depending upon the intended application of the adhesive material. The adhesive material of the present teachings may be applied to various articles of manufacture for adhering a first surface to a second surface. The adhesive material may be applied to a first surface material of one or more automotive components for attachment of the one or more automotive components to a second surface material that differs from the first surface material. As an example, the adhesive material may be applied to a metal surface of one or more automotive components for adhesion to a glass surface of one or more automotive components. The present teachings contemplate applying the adhesive material to one or more surfaces of one or more components in a pre-activated state and activating the material for curing and/or thermosetting the adhesive material. Upon activation, the adhesive material typically wets the surfaces that the material contacts to adhere and bonds to those surface (e.g., through curing and/or thermosetting).

Percentages herein refer to weight percent, unless otherwise indicated.

Epoxy resin is used herein to mean any of the conventional epoxy materials containing at least one epoxy functional group. The epoxy resin may be any epoxy resin that may be used to adhere two or more materials together. Preferably, the epoxy resin may be any epoxy resin so that the epoxy resin once cured adheres two or more materials together and allows the cured adhesive to be less brittle. In addition, a rubber component may be included with the epoxy to provide for an adhesive where the resulting adhesive is less brittle than it would be in the absence of the rubber component. More preferably, the epoxy resin may be any epoxy resin that adheres to metal and glass and may withstand temperature and humidity variations. The epoxy resins may be difunctional, trifunctional, multifunctional, or any combination thereof. Moreover, the term epoxy resin can be used to denote one epoxy resin or a combination of multiple epoxy resins. The epoxy resin may be a solid epoxy or a liquid epoxy. The adhesive material may include about 5 percent by weight epoxy or more, preferably about 15 percent by weight epoxy or more, more preferably about 25 percent by weight or more, even more preferably about 40 percent by weight epoxy or more, or most preferably about 50 percent by weight epoxy or more. The adhesive material may include about 90 percent by weight epoxy or less, about 85 percent by weight epoxy or less, or about 80 percent by weight epoxy or less. The adhesive material may include between about 20 percent and about 85 percent by weight epoxy resin, preferably between about 45 percent and about 80 percent by weight epoxy resin, and more preferably between about 50 percent and about 78 percent by weight epoxy resin. As discussed, the percentage epoxy resin by weight includes both solid and liquid epoxy. As an example, it is contemplated that weight percentages may be lower or higher when other ingredients such as elastomers, impact modifiers, crosslinking agents, fillers, alternative polymers, and combinations thereof, are used in greater or lesser weight percentages.

The epoxy may be aliphatic, cycloaliphatic, aromatic, or the like The epoxy may be supplied as a solid (e.g., as flakes or pellets) or a liquid or both. An epoxy resin is added to the adhesive material to create a thermoset and to increase the adhesion, flow properties, or both, of the material. As an example, the epoxy resin may be a phenolic resin, which may be a novalac type or other type resin. For example, bisphenol A resin, bisphenol F resin, or a combination thereof may be employed. Moreover, various mixtures of several different epoxy resins may be employed as well. Examples of suitable epoxy resins are sold under the tradename DER® (e.g., DER 331, DER 661. DER 662. DER 664) commercially available from the Dow Chemical Company, Midland, Mich.

The epoxy resin may be comprised of about 20% or more, more typically about 30% or more and even possibly about 40% or more by weight thereof of liquid epoxy resin (e.g. a resin that has a molecular weight such that it is liquid at 23° C.). The epoxy resin may be comprised of about 100% or less, about 90% or less, or preferably about 80% or less by weight liquid epoxy resin. Such liquid epoxy resin typically has a viscosity at a temperature of 23° C. of about 5 Pa*S or more and typically about 22 Pa*S or less, although higher and lower values may also be possible. The liquid epoxy resins may include diglycidyl ethers that may be aromatic phenol based (bisphenol A or F) such as those sold under the tradenames DER 331 (commercially available from the Dow Chemical Company). The liquid epoxy resins may be epoxy phenol novolac based such as those sold under the tradename Epalloy 8250 (commercially available from CVC Thermoset Specialties, Moorestown, N.J.).

The epoxy resin may be comprised of about 20% or more, preferably about 30% or more, and more preferably about 40% or more by weight thereof of solid epoxy resin (e.g., a resin that has a molecular weight such that it is solid at 23° C.). The epoxy resin may be comprised of about 100% or less, about 90% or less, or preferably about 80% or less by weight solid epoxy resin. Preferred solid resins include diglycidyl ethers that may be aromatic phenol based (bisphenol A or F) and are sold under the tradenames DER 662 and DER 664, commercially available from the Dow Chemical Company.

The adhesive may include a solid epoxy and a liquid epoxy. The ratio of solid epoxy to liquid epoxy may be any ratio so that when the green adhesive including the epoxy mixture and the second surface are applied to the first surface, the second surface and/or the adhesive do not move along the first surface, fall off the first surface, or both. The ratio of solid epoxy to liquid epoxy may be any ratio so that the viscosity of the green adhesive is low enough so that the adhesive may be evenly applied to a surface. The ratio of solid epoxy to liquid epoxy may be any ratio so that the green state adhesive holds the first surface and the second surface static relative to each other before curing, during curing, or both. The ratio of solid epoxy to liquid epoxy may be about 1:1 or greater, about 1.2:1 or greater, or preferably about 1.4:1 or greater. The ratio of solid epoxy to liquid epoxy may be about 1:2 or less, about 1:1.5 or less, or about 1:1.2 or less. Preferably, the ratio of solid epoxy to liquid epoxy is between about 1:1 and about 3:1 and preferably between about 1.2:1 and about 2.5:1.

The epoxy resin may include a rubber. The rubber may be any rubber that allows the epoxy resin to retain some ductility (i.e., reduce the brittleness of the adhesive), toughness, or both before curing, after curing, or both. The rubber may allow the adhesive to elongate without breaking, cracking, fracturing, becoming unattached to one of the surfaces, or a combination thereof. Some rubbers that may be used are: carboxyl terminated butadiene acrylonitrile (CTBN), carboxyl terminated butadiene (CTB); core shell, polybutadiene, polybutadiene with maleic anhydride, or a combination thereof. The rubber may be non-reactive with the epoxy resins. An example of a nonreactive rubber-containing component is Kane Ace MX 136 available from Kaneka. Kane Ace MX 136 is a dispersion consisting of 25% by weight core shell rubber based on polybutadiene with 75% by weight liquid epoxy resin based on Bisphenol F. The rubber may have reactive groups that can react with epoxy resins. An example of a rubber with groups that can react with epoxide groups is a carboxyl terminated butadiene acrylonitrile (CTBN) rubber. The CTBN rubber may be mixed into the epoxy resin using elevated temperature and possibly a catalyst such as triphenylphosphine to create a reaction component. The epoxy may include about percent by weight or more rubber, about 15 percent by weight or more rubber, or preferably about 25 percent by weight or more rubber. The epoxy may include about 45 percent by weight or less, about 35 percent by weight or less, or about 30 percent by weight or less rubber (i.e., about 30 percent by weight rubber). The epoxy may include between about 20 percent by weight and about 30 percent by weight rubber. The total composition may include about 3 percent by weight or more, about 5 percent by weight or more, or about 7 percent by weight or more rubber (i.e., about 7.5 percent by weight rubber). The total composition may include between about 2 percent by weight and about 15 percent by weight or about 5 percent by weight and about 10 percent by weight rubber. The reaction component may be referred to herein as part of the epoxy. For example, the rubber may be mixed into a resin and then the amount of rubber added to the composition may be recited by one of the weight percentages of epoxy recited herein However, the amount of rubber added to the adhesive may be a sufficient amount so that the adhesive includes ductility, toughness, or both. The amount of rubber added may be a sufficient amount so that the cured adhesive has an elongation of about 1 percent or more, about 2 percent or more, or even about 2.5 percent or more. The amount of rubber added may be a sufficient amount so that the cured adhesive has an elongation of between about 1 percent and about 10 percent, preferably about 2 percent and about 7 percent, or more preferably between about 2.5 percent and about 6 percent.

The adhesive material will typically include one or more additional polymers or copolymers, which can include a variety of different polymers, such as thermoplastics, elastomers, thermosets, combinations thereof, or the like. For example, and without limitation, polymers that might be appropriately incorporated into the polymeric admixture include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyvinyl butyral, polyolefin (e.g., polyethylene, polypropylene) polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacryate), poly(vinyl acetate), poly(vinylidene chloride), polytetrafluoroethylene, polyisoprene, polyacrylamide, polyacrylic acid, polymethacrylate.

The polymeric mixture may include a reactive polyethylene copolymer resin that is modified with one or more reactive groups such as glycidyl methacrylate or maleic anhydride. Examples of such polyethylene resins are sold under the tradename LOTADER® (e.g., LOTADER AX 8900) and are commercially available from Arkema Group.

The polymeric mixture may also include one or more halogenated elastomers or rubbers, (e.g., a brominated, chlorinated or fluorinated elastomer). It is contemplated that the halogenated elastomer may be provided as a liquid, a solid, or both. Preferably, the composition includes up to about 15% by weight of a halogenated elastomer, more preferably between about 3% and about 13% by weight of a halogenated elastomer and still more preferably between about 4% and about 12% by weight of a halogenated elastomer. One exemplary suitable halogenated elastomer is a brominated elastomer that is derived from a copolymer of isobutylene and p-methylstyrene. Such an elastomer is sold under the tradename EXXPRO®, commercially available from Exxon Mobil Chemical, Houston, Tex.

The polymeric mixture may include one or more elastomers or rubbers that are not halogenated. For example, the elastomers or rubbers may be free of bromine, chlorine, or fluorine. The rubber component may be integrated with the epoxy component. As an example, the adhesive composition may include a solid epoxy/CTBN product. The adhesive composition may include a liquid epoxy/core shell polymer product.

The polymeric mixture may also include an ethylene vinyl acetate (EVA) copolymer having a vinyl acetate content of between about 20% and about 35% by weight, such EVA being sold under the tradename ELVAX 210 and being commercially available from E.I. Dupont De Nemours and Company, Wilmington, Del. The polymeric mixture may also include one or more ethylene-methyl acrylate copolymers, each having a methyl acrylate content of from about 18% to about 28%. Examples of such ethylene-methyl acrylate copolymers include Optema TC-220 and Optema TC-130 available from Exxon Mobil Chemical, Houston, Tex. The ethylene-methyl acrylate copolymers may act to increase ductility of the adhesive and to improve adhesion capability of the adhesive. The EVA may be any EVA that adjusts the melt viscosity of the polymeric mixture in such a way that the two surfaces do not move in relation to one another. The EVA may be cured in order to improve the adhesion strength between the first surface and the second surface.

The polymeric mixture may include one or more ethylene methacrylate (EMA) copolymers. The polymeric mixture may include more than one ethylene methacrylates with different melt indexes. The melt index of the EMA copolymers may be about 1 or greater, about 3 or greater, or about 5 or greater. The melt index of the EMA may be about 50 or less, about 40 or less, about 30 or less, or about 25 or less. Preferably, the melt index of one EMA added may be about 5 and the melt index of a second EMA added may be about 20. Each EMA may be added to the polymeric mixture in an amount of about 1 percent by weight or more, about 2 percent by weight or more, or about 3 percent by weight or more. Each EMA may be added to the polymeric mixture in an amount of about 20 percent or less, about percent or less, or preferably about 10 percent or less. Each EMA may be present in an amount of between about 1 percent by weight and about 15 percent by weight, preferably between about 2 percent by weight and about 12 percent by weight, or more preferably between about 3 percent by weight and about 9 percent by weight.

When used, these polymers can comprise a small portion or a more substantial portion of the adhesive material (e.g., up to 85% by weight or greater). The polymeric mixture may comprise about 0.1% to about 50%, more preferably about 1% to about 40%, and even more preferably about 10% to about 30% by weight of the adhesive material.

One or more curing agents and/or curing agent accelerators may be added to the adhesive material. Amounts of curing agents and curing agent accelerators can vary. Exemplary ranges for the curing agents or curing agent accelerators present in the adhesive material range from about 0.001% by weight to about 9% by weight and more typically from about 1% to about 5% by weight.

The adhesive may include a primary curing agent. The primary curing agent may be any curing agent that once cured may permanently secure two surfaces together. The primary curing agent may cure at a temperature of about 90° C. or more, about 120° C., preferably about 135° C. or more. The primary curing agent may cure at a temperature of about 260° C. or less, about 205° C. or less, or preferably about 175° C. or less. Curing of the primary curing agent may occur at a temperature between about 110° C. and about 230° C., preferably about 115° C. and about 190° C. or more preferably about 135° C. and about 150° C. The primary curing agent may cure about 75 percent or more, about 80 percent or more, about 85 percent or more of the epoxy available. Preferably, the primary curing agent will cure all of the epoxy that is not cured by the secondary curing agent. For example, the secondary curing agent may quickly cure a sufficient amount of epoxy so that the first surface and second surface remain static as the adhesive begins wetting and the primary curing agent may cure the rest so that the first surface and the second surface are fixedly secured to each other.

The adhesive may include a secondary curing agent. The secondary curing agent may be any curing agent that at least temporarily secures the surfaces together. The secondary curing agent may be a low temperature curing agent. Preferably, the secondary curing agent may cure at a lower temperature than the primary curing agent so that the secondary curing agent begins curing the epoxy first. The secondary curing agent may cure at a temperature of about 50° C. or more, preferably about 60° C. or more, and most preferably about 65° C. or more. The secondary curing agent may cure at a temperature of about 95° C. or less, about 83° C. or less, or about 75° C. The secondary curing agent may cure at a temperature of between about 38° C. to about 88° C. or preferably between about 55° C. and about 75° C. The secondary curing agent may cure about 10 percent or more, about 15 percent or more, or about 18 percent or more of the available epoxy. Most preferably, the secondary curing agent will not cure more than about 25 percent. The secondary curing agent may cure between about 5 percent and about 25 percent of the epoxy or preferably between about 15 percent and about 20 percent of the epoxy. The secondary curing agent may cure the epoxy in an oven, an autoclave, or both. The secondary curing agent may begin curing the epoxy outside of an oven or autoclave. The secondary curing agent may begin curing the epoxy due to the temperature of the first surface. For example, the first surface may be heated or retain heat and this heat may be enough to begin curing the adhesive when the adhesive and the second surface are applied to the first surface. The adhesive may be free of a secondary curing agent.

The adhesive may include a peroxide curing agent. The peroxide curing agent may cure at a temperature of about 100° C. or more, preferably about 120° C. or more. The peroxide curing agent may cure at a temperature of about 200° C. or less, or even about 170° C. or less. The peroxide curing agent may cure at a temperature of between about 120° C. to about 170° C. The peroxide curing agent may be used to cure any of the ingredients discussed herein that may be cured. Preferably, the peroxide curing agent may be any curing agent that may cure an EVA copolymer. The peroxide curing agent may be added in any amount so that the ingredients of the adhesive are sufficiently cured. The peroxide curing agent may be added in an amount of about 0.5 percent by weight or more, about 1.0 percent by weight or more, or about 1.25 percent by weight or more. The peroxide curing agent may be added in an amount of about 10 percent by weight or less, about 5 percent by weight or less, or about 3 percent by weight or less (i.e., about 1.5 percent by weight).

Preferably, the curing agents assist the adhesive material in curing by crosslinking of the polymers, epoxy resins, other ingredients in the material or a combination thereof. Useful classes of curing agents include agents that cross-link the epoxy resin and/or other ingredients by addition reaction or catalyzed reaction. The curing agent materials can be selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), dihydrazides, sulfonamides, diamino diphenyl solfone, anhydrides, mercaptans, imidazoles, ureas, tertiary amines, BF3 complexes or mixtures thereof. Particular preferred curing agents include modified and unmodified polyamines or polyamides such as triethylenetetramine, diethylenetriamine tetraethylenepentamine, cyanoguanidine, dicyandiamides and the like. Examples of curing agents may be Ancamine® CG-1200G and Ancamine® 2337S available from Air Products.

The curing agents may be activated by mixing with the other ingredients of the adhesive material or by exposure to a condition such as radiation, moisture, pressure, or the like. In a preferred embodiment, the curing agent is heat activated.

The curing temperature of the primary curing agent, the secondary curing agent, the tertiary curing agent, or any combination thereof may be adjusted by an accelerator. The curing time of the primary curing agent, the secondary curing agent, the tertiary curing agent or any combination thereof may be reduced using an accelerator. A sufficient amount of accelerator may be added so that one or more of the curing stages occurs at a temperature of between about 110° C. and about 230° C., preferably about 115° C. and about 190° C., or more preferably about 135° C. and about 150° C. (i.e., about 140° C.). A sufficient amount of accelerator may be added to the curing agent so that curing occurs in about 2 hours or less, about 90 minutes or less, or preferably about 60 minutes or less. A sufficient amount of accelerator may be added to the curing agent so that curing occurs in between about 10 minutes and two hours, preferably about 20 minutes and 60 minutes, or more preferably between about 30 minutes and 45 minutes. The amount of accelerator used may be any amount so that the curing temperature is reduced enough to cure the epoxy in an oven. The amount of accelerator used may be any amount so that the ductility, shelf life, or both are not adversely affected. An accelerator for the curing agents (e.g., a modified or unmodified urea such as methylene diphenyl bis urea, an imidazole, blocked amine, an amine adduct or a combination thereof) may also be provided for preparing the adhesive material. The amount of accelerator added may be about 0.1 percent by weight or more, about 0.2 by percent weight or more, about 0.5 by percent weight or more, or even about 0.75 percent by weight or more. The amount of accelerator added may be about 2 percent by weight or less, about 1.5 percent by weight or less, or about 1 percent by weight or less The adhesive may be substantially free of an additional accelerator. An example of one preferred accelerator is Omicure U 52 M available from CVC Thermoset Specialties. Another example accelerator is PN-23 available from Ajicure.

The composition may include one or more additives (e.g., functional additives) for improving one or more various properties of the composition. As examples, additives may include antioxidants, antiozonants, ultraviolet absorbers, ultraviolet resistant agents, lubricant, antistatic agents, colorants, coupling agents, flame retardants, blowing agents, heat stabilizers, impact modifiers, plasticizers, preservatives, processing aids and stabilizers, reinforcement/filler (e.g., chopped or continuous glass, ceramic, aramid, or carbon fiber, particulates or the like), or combinations thereof, or the like.

One additive, which may be provided in the composition is a tackifier (e.g., a tackifying polymeric mixture), which may be added to the composition for enhancing adhesion, peel strength or both. The tackifier may be a hydrocarbon based tackifier such as an aromatically modified C5 or C5:C9 hydrocarbon tackifying polymeric mixture. When included, the tackifying polymeric mixture is up to about 25% by weight of the composition. The tackifier may comprise from about 2% to about 20% by weight of the composition. The tackifier may comprise from about 8% to about 15% by weight of the composition. One exemplary tackifier is sold under the tradename WINGTACK, commercially available from Goodyear Chemical, Akron, Ohio.

The adhesive material may also include one or more fillers, including but not limited to particulated materials (e.g., powder), beads, microspheres, or the like. The filler may include a material that is generally non-reactive with the other components present in the adhesive material. The filler may include a material that is reactive with the other components present in the adhesive material. Any filler may be used that improves the sag characteristics of the adhesive. Specifically, any filler may be used that improves sag characteristics of the green state (prior to cure and/or activation) adhesive when the adhesive is applied to the two surfaces. The filler may be any filler that minimizes flow characteristics of the adhesive. For example, when the green state adhesive is placed between two surfaces the surfaces will remain substantially static relative to each other (i.e., one surface will not flow or move). Preferably, a sufficient amount of a filler may be added to the adhesive to improve the adhesive's green sag performance. More preferably, a clay filler may be added to the adhesive so that the adhesive is free of sag. Any amount of filler may be added to the adhesive so that sag characteristics are improved. The adhesive may include about 1 percent by weight filler or more, preferably about 3 percent by weight filler or more, or more preferably about 5 percent by weight filler or more. The adhesive may include about 15 percent by weight filler or less, about 12 percent by weight filler or less, or about 10 percent by weight filler or less. The adhesive may include between about 2 percent and about 12 percent by weight filler or preferably between about 4 percent and about 9 percent by weight filler. While the fillers may generally be present within the adhesive material to take up space at a relatively low weight, it is contemplated that the fillers may also impart properties such as strength, dimensional stability, and impact resistance to the activatable material.

Examples of fillers include silica, pulp, diatomaceous earth, glass, clay (e.g., including nanoclay), talc, pigments, colorants, glass beads or bubbles, glass, carbon or ceramic fibers, nylon or polyamide fibers (e.g. Kevlar), and the like. Examples of suitable fillers include, without limitation, wollastonite, talc, vermiculite, pyrophyllite, sauconite, saponite, nontronite, montmorillonite, or mixtures thereof. Clays usable for the adhesive material may be calcined or uncalcined. Clays that may be used as fillers may include clays from the kaolinite, illite, chloritem, smecitite or sepiolite groups, which may be calcined. The clays may also include minor amounts of other ingredients such as carbonates feldspars, micas and quartz. Preferably, clay may be used in a sufficient amount so that during the curing process the surfaces do not move relative to each other (e.g. one surface does not slide as the adhesive liquefies). An example of one clay that may be used is Garamite 1958, available from Southern Clay Products.

Preferred fillers that reduce sag and optimize viscosity of the adhesive include Garamite 1958 from Southern Clay, Cabosil TS 720 fumed silica from Cabot Corporation, Polytrol FT from Poly-Resyn, Inc., an aramid pulp, or calcium carbonate.

One particular filler that may be used is a magnetic filler. Preferably, if a magnetic filler is used the filler is a strontium ferrite filler. Once the adhesive which contains the strontium ferrite filler is passed over a strong magnetic field, the strontium ferrite imparts magnetic characteristics to the adhesive. The strontium ferrite filler may be added in any amount so that the filler reduces sag. The strontium ferrite filler may be added in any amount so that the magnetic particles assist in adhering the second surface to the first surface during the procured state, during curing, after curing, or a combination thereof. The strontium ferrite filler may be present in a sufficient amount so that the strontium ferrite filler assists in holding the second surface on the first surface. The strontium ferrite filler may be added in an amount of about 10 percent by weight or greater, about 20 percent by weight or greater, about 30 percent by weight or greater, or even about 35 percent by weight or greater. The strontium ferrite filler may be added in an amount of about 70 percent by weight or less, about 60 percent by weight or less, about 50 percent by weight or less, or even about 45 percent by weight or less. The strontium ferrite filler may be added in an amount of between about 30 percent by weight and about 50 percent by weight and preferably between about 35 percent by weight and 45 percent by weight.

One or more mineral or stone type fillers such as calcium carbonate, sodium carbonate or the like may be used as fillers. Silicate minerals such as mica may also be used as fillers. A silica may be used as a filler. A fumed silica may be used as a filler.

The final adhesive composition (i.e. the adhesive in its green state once all of the components have been added and mixed together) may have any viscosity so that the adhesive holds a first surface to a second surface and the first surface and second surface remain static relative to each other. The final adhesive composition may have a sufficient viscosity so that the adhesive holds the first surface static relative to a second surface when the adhesive begins to soften during cure so that the first surface, the second surface or both are free of sag. The viscosity of the final adhesive is about 1000 Pa*S or more, about 1200 Pa*S or more, about 1500 Pa*S or more, or even about 2000 Pa*S or more. The viscosity of the final adhesive may be about 20,000 Pa*S or less, about 17,000 Pa*S or less, or about 15,000 Pa*S or less. The viscosity was measured using an Ares G2 rheometer outfitted with a FCO Controller. The test was performed using a parallel plate configuration. The specimen was circular with a diameter of 25.4 millimeters and a thickness of approximately 1.5 millimeters. The test was performed at a temperature of 30° C. The test was run using a strain of 1% and a normal force of approximately 132 grams. The test frequency was from 0.1 to 100 radians per second.

Formation of the adhesive material can be accomplished according to a variety of techniques. The adhesive material may be formed as a material of substantially mixed and/or homogeneous composition prior to activation thereof. However, it is contemplated that various combining techniques may be used to increase or decrease the concentration of certain components in certain locations of the activatable material.

The adhesive material may be formed by supplying the components of the material in solid form such as pellets, chunks and the like, in liquid form, or a combination thereof. The components may be combined in one or more containers such as large bins or other containers. Preferably, the containers can be used to intermix the components by rotating or otherwise moving the container. All of the ingredients may be added to one container and mixed (e.g. wet mixed or dry mixed) together. Two or more ingredients may be mixed together separately and then added to the other ingredients that are mixed together. Two or more components may be mixed together forming a reaction component and then the reaction component may be mixed with other components to form the adhesive. For example, two or more ingredients may be separately mixed together and once mixed the other ingredients may be mixed together with those ingredients. In another example, two ingredients may be mixed in a first step and two different ingredients may be mixed together in a second step and then the ingredients from step one and step two may be combined in a third step. In a step of mixing, the ingredients may be heated so that the ingredients liquefy.

The liquefied ingredients may be cooled and formed into a shape (e.g. pellet, block, or other small solid piece). Preferably, the high molecular weight ingredients are mixed together in a separate step. More preferably, the high molecular weight ingredients are mixed together in a high shear batch process prior to being mixed to the other ingredients. Thereafter, heat, pressure, or a combination thereof may be applied to soften or liquidize the components such that the components can be intermixed by stirring or otherwise into a substantially mixed or homogenous composition. The adhesive material may be formed by heating one or more of the components that are generally easier to soften or liquidize such as the polymer based materials to induce those components into a mixable state. Thereafter, the remaining components may then be intermixed with the softened components.

It is also contemplated for any of these embodiments that the material can be provided individually, as admixtures or combinations thereof to an extruder. The extruder then mixes the materials to form the adhesive materials. The mixing of the extruder may be a third step of mixing. The mixing of the extruder may occur after a third step of mixing. Even further, it is contemplated that the adhesive material may be fully mixed and formed and then fed to an extruder for dispensing as discussed further below. Mixing may be performed in a twin screw extruder. A final mixing step may be performed in a twin screw extruder. The twin screw extruder may include one or more ports for adding additional ingredients. The twin screw extruder may include one port, two ports, three ports, four ports, five ports, or more for adding ingredients to the twin screw extruder. The ingredients may be added to the twin extruder in any order so that an adhesive is achieved. The first feed port, second feed port, third feed port, fourth feed port, or a combination thereof may be used to add high molecular weight resins, low molecular weight resins, liquid resins, temperature sensitive ingredients, or a combination thereof. Preferably, the first feed port may be used to add high molecular weight resins. Preferably, the second feed port may be used to add lower molecular weight resins or liquid resins. Preferably, the third feed port may be used to add lower molecular weight resins or liquid resins. Preferably the fourth feed port may be used to add temperature sensitive ingredients such as curing agents, accelerators, or both.

As a specific example, the epoxy reacted with carboxyl terminated butadiene acrylonitrile rubber is dry blended with the ethylene terpolymer and some of the clay filler. In another step, the remainder of the clay filler is dry blended with the primary curing agent, the secondary curing agent, the primary curing agent accelerator and the pigment. The blend of the epoxy and ethylene terpolymer is added near the feed throat of a twin screw extruder. The liquid epoxy is pumped into the twin screw extruder either in one location or in two different locations of the twin screw extruder. Finally, the blend containing the curing agents is added closer to the end of the twin screw extruder. The screws for the twin screw extruder are specifically designed to allow the three feed streams that go into the twin screw extruder to produce a homogeneous blend. The high molecular weight ingredients are added near the feed throat since they require more heat and residence time in the barrel of the extruder. The liquids are introduced in a way that does not reduce the shear needed to properly compound the high molecular weight ingredients. The blend containing the curing agents are introduced into the extruder close to the exit of the extruder to minimize the amount of exposure of the blend to high temperatures that could initiate curing. The screw speed and material throughput are adjusted to a maximum but taking care that the temperature of the extrudate is kept as low as possible.

As a specific example, the halogenated elastomer may be combined with the high molecular weight solid polymers such as the solid epoxy, the polymeric mixture and the tackifier, in addition to at least a portion of the filler materials. This combination may then be heated, mixed, and pelletized. The resulting pellets may then be fed into an extruder along with the remaining liquid components, including the liquid epoxy, liquid polybutadiene and liquid bipentaerythritol pentaacrylate monomer (a curing co-agent). Any remaining curatives, fillers and pigments are also combined by feeding into the extruder and the resulting material is formed into an adhesive sheet which may be rolled to a desired thickness and die-cut to a particular shape.

The method of making the adhesive may include extruding the adhesive after the adhesive is mixed. Extrusion may be performed continuously with the mixing step in an in-line process. Alternatively, the adhesive may be extruded in a process separate from the mixing step. The material may be extruded on to a release liner. An additional release liner may be laminated on to the top of the material as it exits the twin screw extruder and before it enters the calendar. The material may be extruded onto a liner (i.e., a bottom liner) and then covered by another liner (i.e., a top liner). The liners may be flat. The liners may include designs. The liners may include a texture that allows air to escape from between the liner and the adhesive. Preferably, the top liner includes a dimple texture so that air escapes from between the adhesive and the liner. The extruded material may be cut into sheets. The extruded material may be wound onto rolls. The extruded material may be calendered so that the adhesive is smooth, a uniform thickness, a uniform width, include a finish, include a chemical finish, have a uniform density, have voids removed, or a combination thereof. The calendered adhesive may be cut into sheet. The calendered adhesive may be rolled. The calendered adhesive may be die cut

The adhesive is applied between a first surface and a second surface so that the surfaces are held together. Preferably, the surfaces may be any material found in an automotive vehicle. More preferably, the surfaces may be two dissimilar materials such as glass (i.e. automotive glass) and metal (e.g. steel, stainless steel, iron, the like, or a combination thereof). The green state adhesive (i.e. uncured or prior to heating) may be tacky so that one or more of the surfaces and the adhesive are held in place before being cured. The adhesive may be placed between a first surface and a second surface using pressure. Preferably, the adhesive may be placed between a first surface and a second surface using pressure and a low amount of heat so that the tackiness of the adhesive in the green state is increased without curing the adhesive. The adhesive may be first applied to the second surface and then the second surface and the adhesive may be applied to the first surface. The adhesive may be disposed on the second surface at room temperature (i.e., the adhesive and the second surface are not heated or cooled). The adhesive may be applied to the first surface, the second surface, or both using a robotic arm. The first surface may be heated and/or warm when the adhesive and the second surface are applied. The heat of the first surface may begin curing the adhesive. The heat of the first surface may begin wetting of the adhesive. The first surface may have a temperature of about 50° C. or more, about 55° C. or more, or about 60° C. or more. The first surface may have a temperature of about 100° C. or less, about 90° C. or less, about 80° C. or less, or about 70° C. or less. After the adhesive material is placed between the two surfaces the adhesive may be cured so that the two surfaces are affixed together via the adhesive. The adhesive may be cured during any step of the automotive manufacturing process. Preferably, the adhesive may be cured in an autoclave. The surfaces may be oriented parallel to the floor (i.e. horizontal) during the heating process. Preferably, the surfaces may be oriented substantially perpendicular to the floor (i.e. vertical) during the heating process.

### EXAMPLES

Table A provides exemplary formulations A through F of embodiments of adhesive materials according to one or more aspects of the present teachings. The numbers provide weight percents of the individual ingredients in the adhesive material.

TABLE A

| | A | B | C | D | E | F |
|---|---|---|---|---|---|---|
| Solid epoxy 1 and rubber | 44.97 | 36.79 | 35.59 | | | |
| Solid epoxy 2 and rubber | | | | 44.64 | | |
| Liquid epoxy (epoxidized | 19.19 | 16.72 | 20.42 | | | |
| phenol novolac) | | | | | | |
| Liquid epoxy and rubber | | | | 31.25 | | |
| Liquid epoxy resin | | | | | 3.00 | 3.00 |
| Solid epoxy resin | | | | | 5.00 | 5.00 |
| Terpolymer of ethylene, | 11.25 | 11.15 | 11.67 | 11.16 | | |
| acrylic ester and glycidyl | | | | | | |
| methacrylate | | | | | | |
| Halogenated rubber | 10.12 | | | | 5.00 | 5.00 |
| Liquid rubber | | 10.03 | 21.00 | | | |
| Solid rubber | | 11.15 | | | | |
| EVA copolymer | | | | | 3.30 | |
| EMA copolymer | | | | | 6.00 | 8.00 |
| (melt index 5) | | | | | | |
| EMA copolymer | | | | | 4.00 | 5.30 |
| (melt index 20) | | | | | | |
| Hydrocarbon resin | | | | | 13.00 | 13.00 |
| Polybutadiene | | | | | 10.00 | 10.00 |
| Dipentaerythritol | | | | | 4.00 | 4.00 |
| pentaacrylate monomer | | | | | | |
| Dicyandiamide | 1.12 | 0.89 | 0.93 | 1.67 | | |
| Blocked amine curing agent | 0.45 | 0.45 | 0.47 | 0.56 | | |
| Amine adduct curing agent | 0.56 | 0.56 | 0.58 | | 0.30 | 0.50 |
| Adipic dihydrazide curing | | | | | 0.10 | |
| agent | | | | | | |
| Urea Accelerator | | | | 0.67 | | |
| Peroxide curing agent | | | | | 1.50 | 1.50 |
| Clay | 5.62 | 5.57 | 8.17 | 8.93 | | |
| Strontium ferrite filler | | | | | | 39.20 |
| Aramid pulp | | | | | 0.50 | 0.50 |
| Amorphous fumed silica | | | | | 5.00 | 5.00 |
| Calcium carbonate filler | 5.62 | 5.57 | | | 39.30 | |
| Carbon black | 1.10 | 1.12 | 1.17 | | | |
| Austin Black | | | | 1.12 | | |

It should be understood that amount of ingredient in table A may be varied by ±5%, ±20%, ±40% of the values listed and that those variances are considered to be ranges of ingredients for the adhesive material of the present teachings. For example, a value of 10±20% results in a range of 8 weight percent to 12 weight percent of the adhesive material.

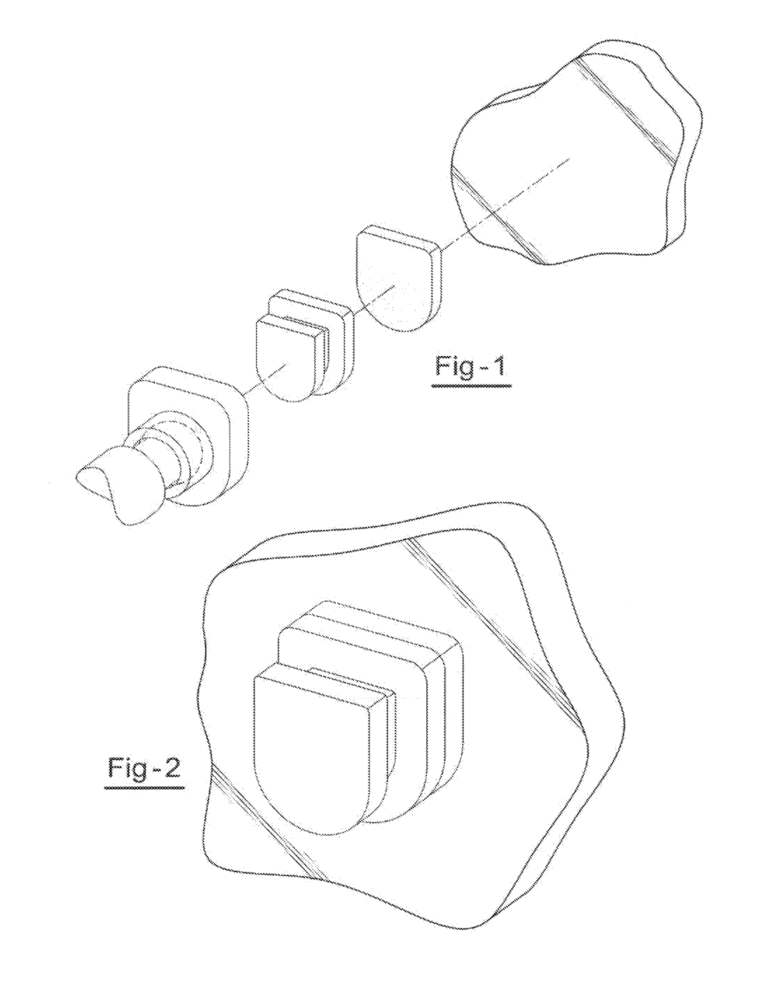

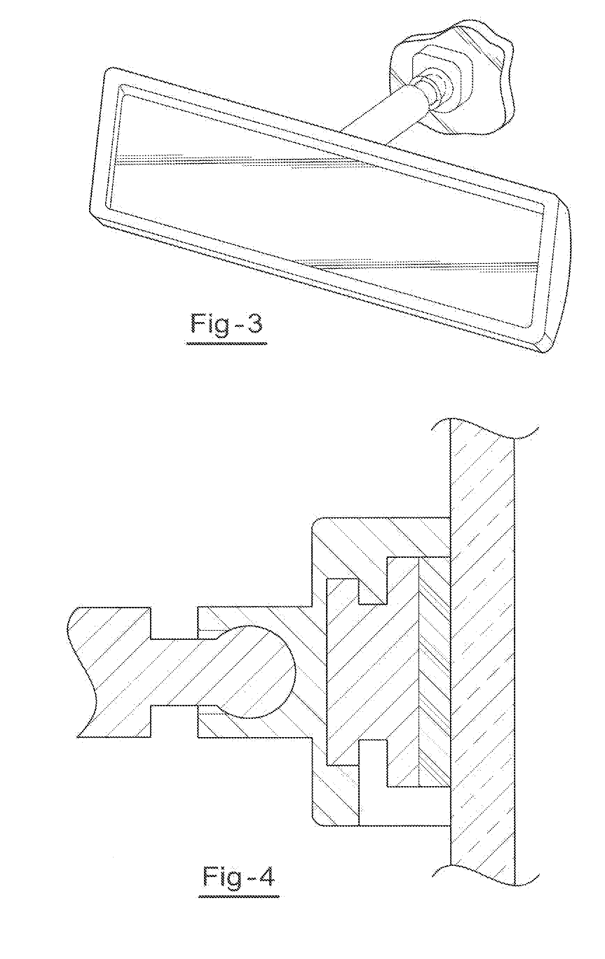

FIG. 1 illustrates a first surface 2 that is a piece of glass, a second surface 4 that is a metal mirror button, and an adhesive 6 as taught herein that has been calendered and die cut. Each component is supplied independently. FIG. 2 shows the adhesive 6 attached to the second surface 4. FIG. 3 illustrates the adhesive 6 securing the second surface 4 to the first surface 2. FIG. 4 illustrates a rear view mirror 8 attached to the first surface 2 via the second surface 4, which is attached to the first surface 2 by the adhesive 6.

FIG. 5 illustrates one possible configuration of the process described herein. The process includes a twin screw extruder 30. The twin screw extruder includes a first feed port 10, a second feed port 12, a third feed port 14, and a fourth feed port 16 for adding components to the twin screw feeder 30 and making an adhesive 24. Once all of the ingredients are added in the various ports the ingredients are mixed and extruded through an extrusion die 18. The extruded adhesive then passes from the extrusion die 18 through the calendering rolls 20 where a uniform thickness and smoothness is achieved. The adhesive is then rolled up in an adhesive roll 22. Optionally, a release film may be added before the calendar, after the calendar, or both so that the adhesive does not adhere to itself once the adhesive is rolled up.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A heat activatable adhesive composition, comprising:
a) at least one liquid epoxy including a rubber and present in an amount of at least about 10% by weight to about 40% by weight of the total adhesive composition;
b) at least one solid epoxy including a rubber and present in an amount of at least about 30% by weight to about 60% by weight of the total adhesive composition
d) an epoxy cure activator that activates curing at a temperature as low as about 120° C.

2. The adhesive composition of claim 1, wherein the at least one epoxy liquid includes a butadiene rubber.

3. The adhesive composition of claim 1, wherein the at least one solid epoxy is a CTBN modified resin.

4. The adhesive composition of claim 1 including at least one curing agent accelerator and at least one filler.

5. The adhesive composition of claim 4, wherein the filer is clay and the filler is present in an amount of between about 3 percent and about 10 percent by weight.

6. The adhesive composition of claim 1, wherein the at least one epoxy liquid includes a core/shell polymer.

7. The adhesive composition of claim 1, wherein the at least one epoxy liquid includes a low viscosity epoxy resin.

8. The adhesive composition of claim 1, wherein the at least one epoxy liquid includes a bisphenol-F epoxy resin.

9. A heat activatable adhesive composition, comprising:
a) a solid epoxy including a CTBN rubber
b) a liquid epoxy including a core/shell polymer;
c) an polyethylene copolymer;
d) a plurality of curing agents; and
f) a clay filler.

10. The adhesive composition of claim 9, wherein the plurality of curing agents includes a dicyandiamide curing agent and a blocked amine curing agent.

11. The adhesive composition of claim 9, wherein the clay filler is present in an amount of between about 3 percent and about 10 percent by weight.

12. The adhesive composition of claim 9, wherein the adhesive is extruded.

13. The adhesive composition of claim 9, wherein the adhesive is calendered.

14. The adhesive composition of claim 9, wherein the adhesive is formed in sheets or formed into a roll.

15. The adhesive composition of claim 9, wherein the adhesive is die-cut.

16. The adhesive composition of claim 15, wherein the die cut adhesive is disposed on a second surface and then the adhesive and second surface are disposed on a first surface.

17. The adhesive composition of claim 16, wherein the adhesive when disposed between the first surface and the second surface includes a sufficient amount of tack in a green state that the first surface and the second surface are free of sag.

18. The adhesive composition of claim 9, wherein the liquid epoxy including a core shell polymer is present in an amount of at least about 10% by weight to about 40% by weight of the total adhesive composition.

19. The adhesive composition of claim 9, wherein the solid epoxy including a CTBN rubber is present in an amount of at least about 30% by weight to about 60% by weight of the total adhesive composition.

20. A heat activatable adhesive composition, comprising:
a) a solid epoxy including a CTBN rubber present in an amount of at least about 30% by weight to about 60% by weight of the total adhesive composition;
b) a liquid epoxy including a core/shell polymer present in an amount of at least about 10% by weight to about 40% by weight of the total adhesive composition;
c) an ethylene copolymer;
d) a plurality of curing agents; and
f) a clay filler present in an amount of between about 3 percent and about 10 percent by weight of the total adhesive composition.
